(19) United States
(12) Patent Application Publication
(10) Pub. No.: US 2004/0021681 A1
(43) Pub. Date: Feb. 5, 2004

(54) Dual-touch-screen mobile computer

(76) Inventor: Chin-Hua Arthur Liao, Taipei (TW)

Correspondence Address: Wei-Fu Hsu, Esq., Bingham McCutchen LLP, Three Embarcadero Center, 18th Floor, San Francisco, CA, 94111, US

(21) Appl. No.: 10/253,210

(22) Filed: Sep. 24, 2002

Related U.S. Application Data
(60) Provisional application No. 60/399,511, filed on Jul. 30, 2002.

(51) Int. Cl. G09G 5/00

(52) U.S. Cl. 345/702; 345/864

(57) ABSTRACT

A dual-touch-screen mobile computer adapted to receive input information by touching a surface of a main screen or a surface of a sub-screen of such mobile computer is provided. The dual-touch-screen mobile computer is essentially a system with a computer module for performing various computer data processing tasks and an embedded system module for performing various embedded system tasks. The dual-touch-screen mobile computer comprises a main screen portion having a main screen mounted on the surface thereof and the computer module mounted within the main screen portion. The dual-touch-screen mobile computer also comprises a sub-screen portion pivotally coupled to the main screen portion and having a sub-screen mounted on the surface thereof and the embedded system module mounted within the sub-screen portion. Both the main screen and the sub-screen are touch-screen type flat panel display screens, thereby allowing a user to input data or commands into the dual-touch-screen mobile computer by physically touching the surface of the main screen or the surface of the sub-screen. The embedded system module is adapted to display a computer input user interface, such as a virtual keyboard, a virtual handwriting board, or a virtual notepad, and an embedded system user interface, such as a PDA interface, a smart phone interface, or a pager interface, on the sub-screen. The dual-touch-screen mobile computer further comprises a mobile phone telecommunication module, an IEEE 802.11 wireless network module, a pager module, a Bluetooth wireless network module, a 10/100 Ethernet module, and a memory card reader. The embedded system module and the computer module have separate battery sets to allow the embedded system module and the computer module to be operated independently.

### CROSS-REFERENCE TO RELATED APPLICATION

This application claims priority from U.S. Provisional Application Serial No. 60/399,511 filed on Jul. 30, 2002.

### FIELD OF THE INVENTION

The present application relates generally to an electronic device and, more specifically, to a duel-touch-screen multi-function notebook computer.

### BACKGROUND OF THE INVENTION

Over the last few decades, hardware and software computer technology has undergone tremendous advancement. Accordingly, the application of computers in almost every field has seen enormous growth. The computers nowadays have become an indispensable part of our daily lives. Business people rely on computers to do business transactions, government officials use computers to serve the public, and students need computers for their education. As a result, many people have to take computers with them for business, school, personal, or other purposes. In response to consumer demand, the computer industry introduced portable computers and later notebook computers to the public in the late 1980s and early 1990s. Although these notebook computers are technically portable, early versions were quite heavy, e.g., with the weight of over 10 lbs or more. Obviously, it's burdensome to carry around a large and heavy notebook computer. Thus, the portability of a notebook computer is usually one of the major factors for a consumer in making his/her purchase decision. For that reason, one of the main goals of the computer industry has been to further reduce the weight and/or the size of notebook computers, thereby improving their portability.

A conventional notebook computer includes a flat panel display screen, e.g., a liquid crystal display (LCD) screen, mounted on a screen casing that is foldable to a main housing of the notebook computer. Typically, the LCD screen is a thin-film-transistor (TFT) LCD screen with a dimension ranging from about 8 to 16 inches in diagonal. Within the main housing of the conventional notebook computer, a motherboard, a hard drive, a memory bank, one or more media drives (e.g., a floppy disk drive, a CD-ROM drive, or a DVD-ROM drive, etc.), a modem and/or network card, and other internal components are densely packed and coupled to each other. The notebook computer's user interface components, such as a keyboard, a touch pad and/or a point stick, and left and right mouse emulation buttons, together with a power-on and other functional buttons are positioned on a surface of the main housing facing the LCD screen when folded. These user interface components allow a user to enter data and/or to control operations of the notebook computer. Moreover, an external mouse can also be hooked up with the notebook computer via an USB port, a serial port, or a wireless connection port thereof to offer the user a more handy way of interacting with the notebook computer. All of these user interface components, i.e., the keyboard, the touch pad, the point stick, the mouse emulation buttons, or the external mouse are generally intuitive, convenient, and easy to use. Most importantly, they can be inexpensively implemented in a conventional notebook computer. Consequently, almost no conventional notebook computer offers other types of input methods, such as a touch-screen type LCD, nor do they incorporate two or more display screens integrated within the notebook computer unit.

Recently, some computer manufacturers have introduced sub-compact type notebook computers (i.e., sub-notebooks) to further improve portability. These sub-notebooks respectively offer a smaller LCD screen, such as of approximately 8 to 10 inches in diagonal, and a thin and light main housing. Their weights typically range between 3 to 5 pounds, which are generally small enough to be easily placed in a briefcase or a backpack. The small physical dimension of a conventional sub-notebook, however, has caused difficulties in, inter alia, fitting and designing the layout of the sub-notebook's keyboard. Generally, the keyboard design of a notebook computer will hit a bottleneck if the LCD screen is smaller than 10 inches or so. This is because 17 mm on each side of a letter key is about the smallest dimension possible without causing undue user inconvenience and/or manufacturing difficulty. As such, it is difficult to shrink the size of a notebook/sub-notebook computer keyboard much beyond this constraint while maintaining a standard keyboard layout. Although further reduction in size can be achieved by repositioning some of the keys, the result is a less conventional keyboard layout which may be unacceptable to the typical consumer.

Like computers, many electronic devices, such as mobile phones, personal digital assistants (PDAs), smart handheld devices, MP3 players, or pagers, etc., have also become an indispensable part of our daily lives. Indeed, a very large percentage of the population in the United States carries at least one of these devices with them wherever they go. Mobile phones and, in a more limited way, pagers provide telecommunication services to their users. Some high-end mobile phones may also provide primitive calendar, contact/address book, and/or wireless email functions. Mobile phones and pagers are typically small enough to be clipped to a belt or other article of clothing or to be stored in a pocket, briefcase or purse. The LCD screen, if any, of a mobile phone or a pager is accordingly minute and of very low quality. Thus, it is difficult for the user to read alphanumeric information displayed on the screen of a mobile phone over a prolonged period of time.

Most PDAs and smart handheld devices offer enhanced functionality in managing personal calendars, contact/address books, personal finance applications, word processing, or possibly wireless email services, etc., as compared to mobile phones. When compared to notebook computers, however, PDAs or other smart handheld devices do not have has the computing power or storage capacity enjoyed by even the smallest notebook/sub-notebook computer. Thus, PDAs and smart handheld devices cannot perform most tasks and software applications that are ordinarily performed by notebook computers. On the other hand, PDAs and smart handheld devices consume much less electricity than notebook computers. This allows their users to operate them with less frequent battery recharges. In addition, all PDAs and smart handheld devices are relatively small, thus allowing them to be carried with ease For instance, the LCD screen of a Compaq/HP iPAQ® PDA has a dimension of approximately 2.4 inches wide by 3.2 inches long with a resolution of about 240×320. Accordingly, like mobile phones, it is difficult for a user to view and operate a PDA or a smart handheld device continuously over a prolonged period of time.

Most of the above-mentioned consumer electronics, i.e., PDAs, notebook computers, and mobile phones, etc., serve distinctive purposes. Consequently, it is not unusual to see an office worker or a student carrying a bulky notebook computer by hand, a PDA in the pocket, a mobile phone on his belt or in her purse, and, in some circumstances, a pager as well. Hence, a solution that offers consumers the convenience and portability of a PDA or mobile phone along with the functionality of a computer is needed.

### SUMMARY OF THE INVENTION

A dual-touch-screen mobile computer adapted to receive input information by touching a surface of a main screen or a surface of a sub-screen is provided. The dual-touch-screen mobile computer is essentially a system with a computer module for performing various computer data processing tasks and an embedded system module for performing various embedded system tasks. The dual-touch-screen mobile computer comprises a main screen portion having a main screen mounted on the surface thereof and a computer module mounted within the main screen portion. The dual-touch-screen mobile computer also comprises a sub-screen portion pivotally coupled to the main screen portion and having a sub-screen mounted on the surface thereof and the embedded system module mounted within the sub-screen portion. Both the main screen and the sub-screen are touch-screen type flat panel display screens, thereby allowing a user to input data or commands into the dual-touch-screen mobile computer by physically touching the surface of the main screen or the surface of the sub-screen. The embedded system module is adapted to display a computer input user interface, such as a virtual keyboard, a virtual handwriting board, or a virtual notepad, and an embedded system user interface, such as a PDA interface, a smart phone interface, or a pager interface, on the sub-screen. The dual-touch-screen mobile computer may also be comprised of a mobile phone telecommunication module, an IEEE 802.11 wireless network module, a pager module, a Bluetooth wireless network module, a 10/100 Ethernet module, and a memory card reader. The embedded system module and the computer module have separate battery sets to allow the embedded system module and the computer module to be operated independently.

Thus, in one aspect, the invention is a portable electronic device comprising a computer portion and an embedded system portion pivotally coupled to the computer portion. The computer portion is adapted to perform various computer data processing tasks and to provide a main screen for displaying a computer user interface. The embedded system portion is adapted to perform various embedded system tasks and to cause to display an embedded system user interface in the portable electronic device. In one preferred embodiment, the embedded system portion includes a sub-screen for displaying the embedded system user interface. In another embodiment, the embedded system user interface can be displayed on the main screen. In the preferred embodiment, the embedded system portion can perform embedded system tasks such as PDA tasks, mobile phone tasks, and pager tasks, and the embedded system user interface is selected by the user from a plurality of embedded system selections including a PDA user interface, a mobile phone user interface, and a pager user interface. In the preferred embodiment, the portable electronic device further includes a wireless local area network port, at least one serial port, a wired local area network port, and a wireless telecommunication module. The wireless local area network port supports at least one of IEEE 802.11a, IEEE 802.11b, IEEE 802.11g, and Bluetooth wireless local area network protocols. In another preferred embodiment, the portable electronic device further includes a multiple memory card reader for reading/writing data from/to a memory card, an embedded system battery set, and a computer battery set. In the preferred embodiment, the computer portion includes an Intel Pentium series CPU and the embedded system portion includes an Intel PXA series CPU. In yet another preferred embodiment, the computer portion includes an AMD Athlon series CPU and the embedded system portion includes an ARM RISC series CPU.

In another aspect, the invention is a portable electronic device comprising a main screen portion and a sub-screen portion pivotally coupled to the main screen portion. The main screen portion includes a computer module mounted within the main screen portion for performing various computer data processing tasks and a main screen mounted on the surface thereof for displaying a computer main user interface. The sub-screen portion includes an embedded system module mounted within the sub-screen portion for performing various embedded system tasks and a sub-screen mounted on the surface thereof for displaying an embedded system user interface or a computer input user interface. In one preferred embodiment, the main screen and the sub-screen are touch-screen type flat panel display screens capable of receiving input information by physically touching a surface of the main screen or a surface of the sub-screen. In the preferred embodiment, the computer input user interface is selectable by the user from a plurality of input methods such as a virtual keyboard, a virtual handwriting board, or a virtual notepad, and the embedded system user interface is selectable by the user from a plurality of embedded system selections such as a PDA user interface, a mobile phone user interface, or a pager user interface. The computer module has a computer central processor unit (CPU) and the embedded system module has an embedded system central processor unit (CPU). Moreover, the portable electronic device may further include a wireless local area network port, at least one serial port, a wired local area network port, and a wireless telecommunication module. The wireless local area network port supports at least one of IEEE 802.11a, IEEE 802.11b, IEEE 802.11g, and Bluetooth wireless local area network protocols. And the wireless telecommunication module supports at least one of GSM (Global System for Mobile Communication), GPRS (General Packet Radio Service), CDMA (Code Division Multiple Access), or 3G (Third Generation) wireless phone communication protocols. In another preferred embodiment, the portable electronic device further includes a memory card reader for reading/writing data from/to a memory card, an embedded system battery set, and a computer battery set. The memory card reader is adapted to read data from or write data to at least one of a plurality of memory medium formats including a compact flash memory card, an IBM Microdrive memory card, a SmartMedia memory card, a Memory Stick memory card, a MultiMedia memory card, and a Secure Digital memory card. In the preferred embodiment, the computer CPU is an Intel Pentium series CPU and the embedded system CPU is an Intel PXA series CPU. In yet another preferred embodiments, the computer CPU is an AMD Athlon series CPU and the embedded system CPU is an ARM RISC series CPU.

A further understanding of the nature and advantages of the present invention may be realized by reference to the remaining portions of the specification and the drawings.

### BRIEF DESCRIPTION OF THE DRAWINGS

FIG. 1 illustrates a simplified configuration of a dual-touch-screen mobile computer according to a preferred embodiment of the present invention;

FIG. 2 illustrates a virtual keyboard layout of the preferred embodiment;

FIG. 3 illustrates an exemplary virtual handwriting board of the preferred embodiment;

FIG. 4 illustrates an exemplary virtual notepad of the preferred embodiment;

FIG. 5 illustrates an exemplary PDA user interface of the preferred embodiment;

FIG. 6 illustrates an exemplary mobile phone user interface of the preferred embodiment;

FIG. 7 illustrates an exemplary pager user interface of the preferred embodiment;

FIG. 8 illustrates an exemplary computer user interface shown on a main screen of the preferred embodiment;

FIG. 9 illustrates an exemplary embedded system user interface shown on a sub-screen of the preferred embodiment;

FIG. 10 illustrates a simplified portion diagram of the preferred embodiment; and

FIG. 11 illustrates a more detailed portion diagram of the preferred embodiment.

### DESCRIPTION OF THE PREFERRED EMBODIMENTS

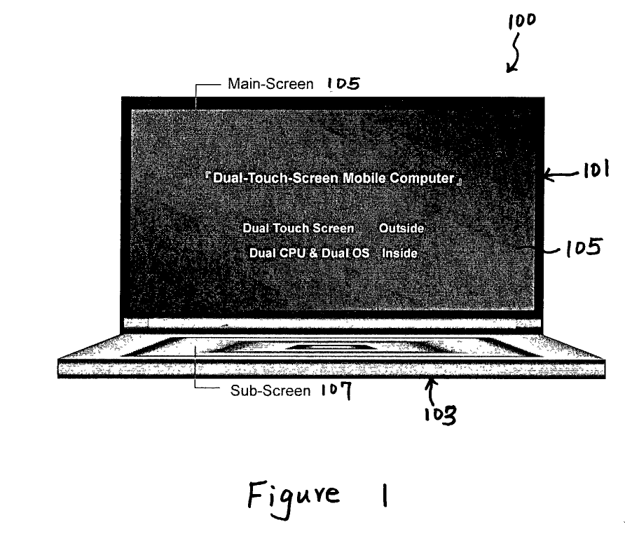

FIG. 1 illustrates a simplified configuration of dual-touch-screen mobile computer 100 according to a preferred embodiment of the present invention. Referring to FIG. 1, the dual-touch-screen mobile computer 100 includes main screen portion 101 and sub-screen portion 103 pivotally coupled to main screen portion 101. Similar to a conventional notebook computer, the main screen portion 101 and the sub-screen portion 103 are foldable over each other, as shown in FIG. 1. The main screen portion 101 includes main screen 105 mounted on the surface thereof and includes computer module 1001, which will be explained in the following paragraphs, that is mounted within main screen portion 101. Similarly, the sub-screen portion 103 includes sub-screen 107 mounted on the surface thereof and embedded system module 1003, which will be explained in the following paragraphs, that is mounted within sub-screen portion 103. The computer module 1001 and the embedded system module 1003 are electrically connected together. As such, the computer module 1001 and the embedded system module 1003 can communicate with and share data between each other.

In the preferred embodiment, the main screen 105 is a touch-screen type SXGA TFT LCD with a dimension of approximately eight inches in diagonal and a resolution of 1024 pixels by 576 pixels. In other embodiments, the main screen 105, however, can also be made of a low temperature poly-silicon (LTPS) type LCD, an organic electroluminescence display (OLED), a LCOS type LCD, or any other type of flat panel display screen that is thin and light and suitable for displaying information thereon. In yet other embodiments, the resolution of main screen 105 can be VGA, XGA, UXGA, or even higher and the dimension of main screen 105 can be of approximately ten inches, twelve inches, or any other suitable size. Moreover, to offer a better visual sensation, the screen ratio (i.e., the length versus the width) of main screen 105 in the preferred embodiment is set to be 16:9. In other embodiments, the screen ratio can be of values other than 16:9.

Like the LCD screen of a conventional notebook computer, the main screen 105 of dual-touch-screen mobile computer 100 is primarily used for displaying to a user a computer display user interface (the computer display UI) that is supported by a computer operating system (the computer OS), such as the Microsoft Windows 95/98/Me/2000/XP operating systems (the Microsoft OSs), the Linux operating system (the Linux OS), or the Apple Macintosh OS X, etc. Typically, the computer display UI is a displayed screen showing software application icons, opened software application windows, and computer status icons, etc. With the computer display UI, the user can monitor hardware/software status, input data or commands, or perform various other tasks on the dual-touch-screen mobile computer 100.

Unlike the conventional notebook computer, however, the main screen 105 of the preferred embodiment is a touch-screen type LCD. Such a touch-screen type LCD allows the user to interact with the computer OS or with many software/firmware applications running under the mobile computer 100 by physically contacting main screen 105 rather than by moving and clicking a mouse or by hitting key strokes on the physical keyboard of the conventional notebook computer. For instance, the user can define a cursor position, press a “button” or “key” shown on main screen 105, or “write” on a notepad displayed on main screen 105 by directly touching or writing on the surface of main screen 105 using a stylus, a touch pen, or even the user's own fingers, etc. On the other hand, for those users who prefer the conventional ways of inputting data, they can still communicate with dual-touch-screen mobile computer 100 by using an externally connected mouse device and/or keyboard via a built-in USB port and/or a serial port of mobile computer 100 or by using a wireless mouse device or a wireless keyboard, etc.

Sub-screen 107 is preferably a sixteen gray-scale monochrome LCD with a dimension of approximately eight inches in diagonal. Like the main screen 105, the sub-screen 107 is also a touch-screen type LCD. Thus, the user can define a cursor position, press a “button” or “key” shown on sub-screen 107, or “write” on a notepad displayed on sub-screen 107 by directly touching or writing on the surface of sub-screen 107 using a stylus, a touch pen, or the user's fingers, etc. In other embodiments, the sub-screen 107 can also be made of a cholesteric LCD, an OLED, a color TFT LCD, or any other type of flat panel screen that is thin and light and suitable for displaying information thereon. In yet other embodiments, the resolution and dimension of sub-screen 107 can be of any values that can adequately display information thereon.

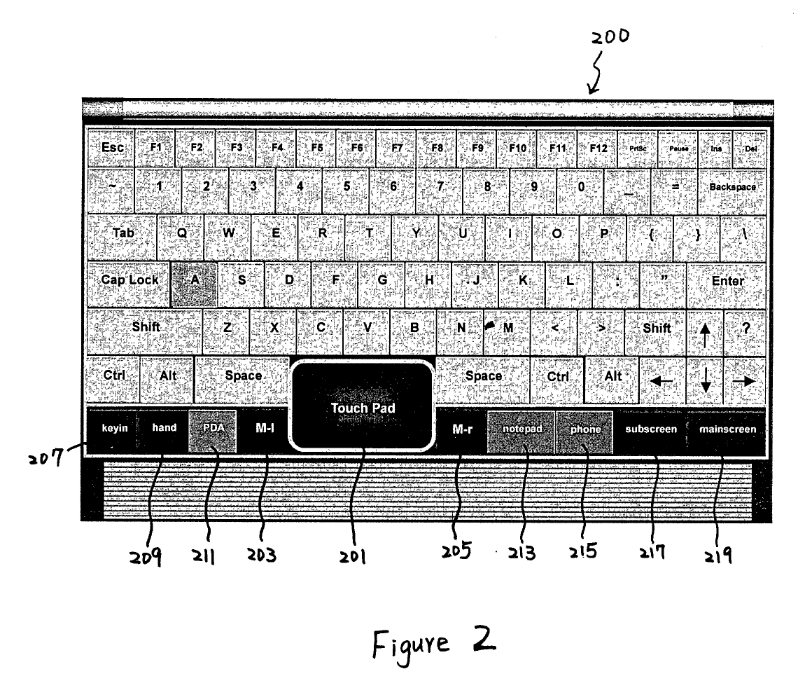

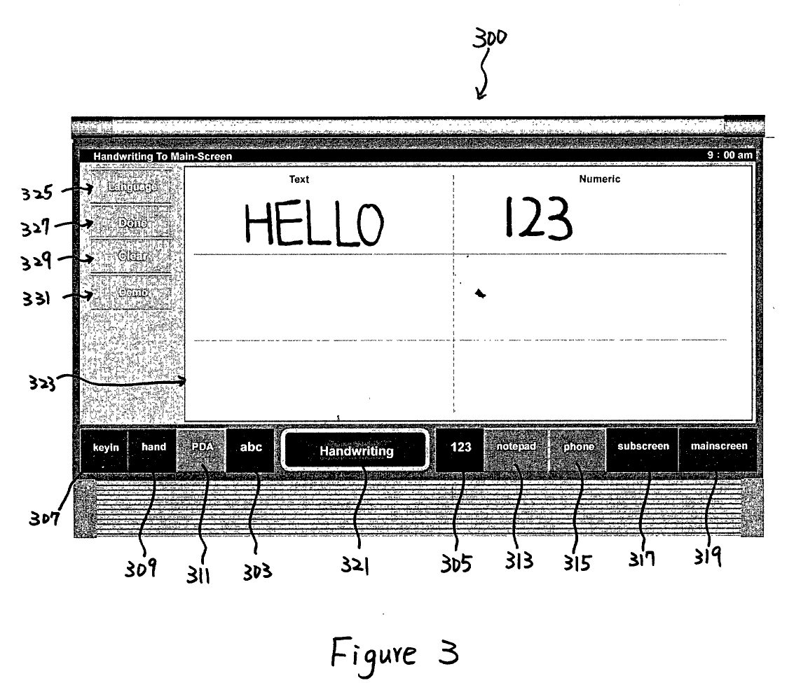

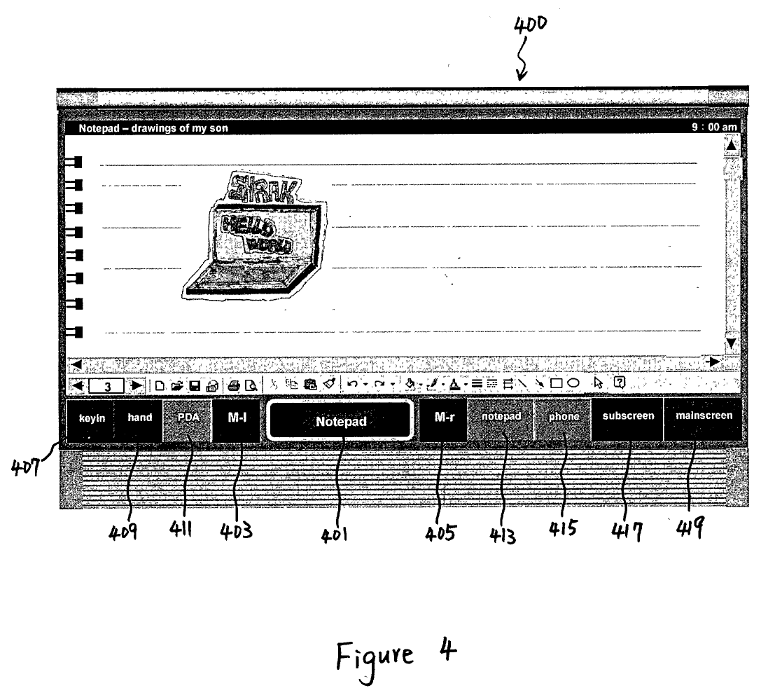

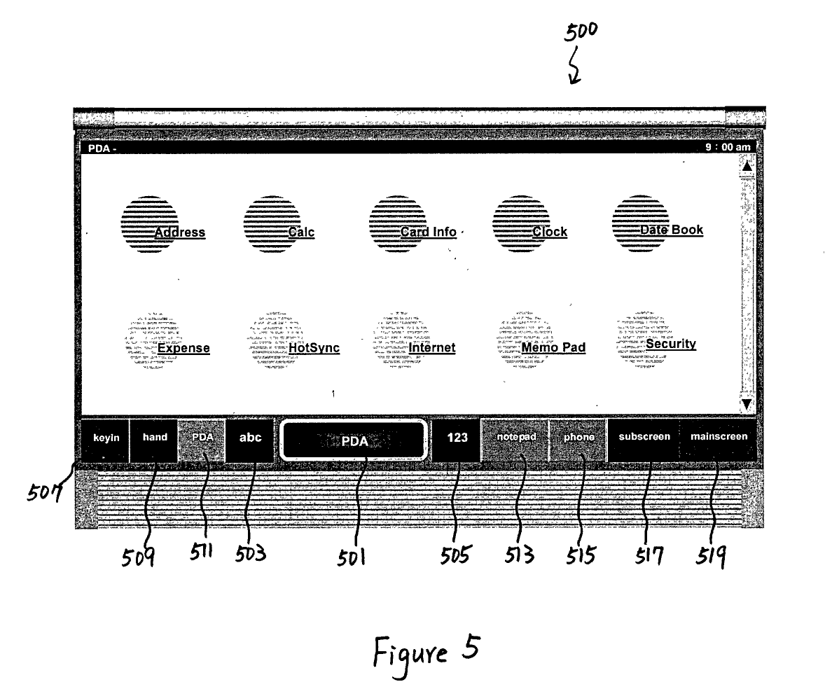

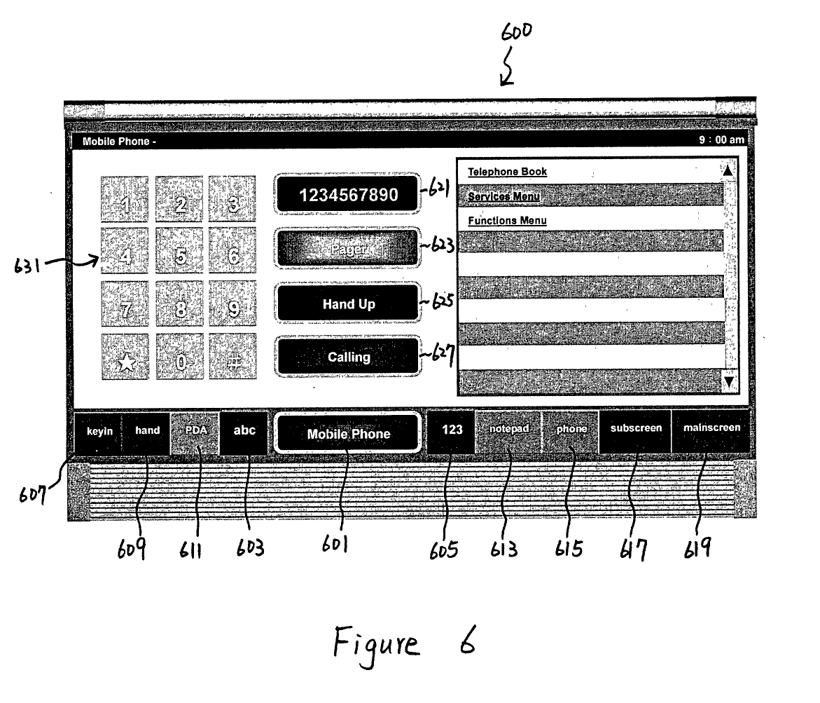

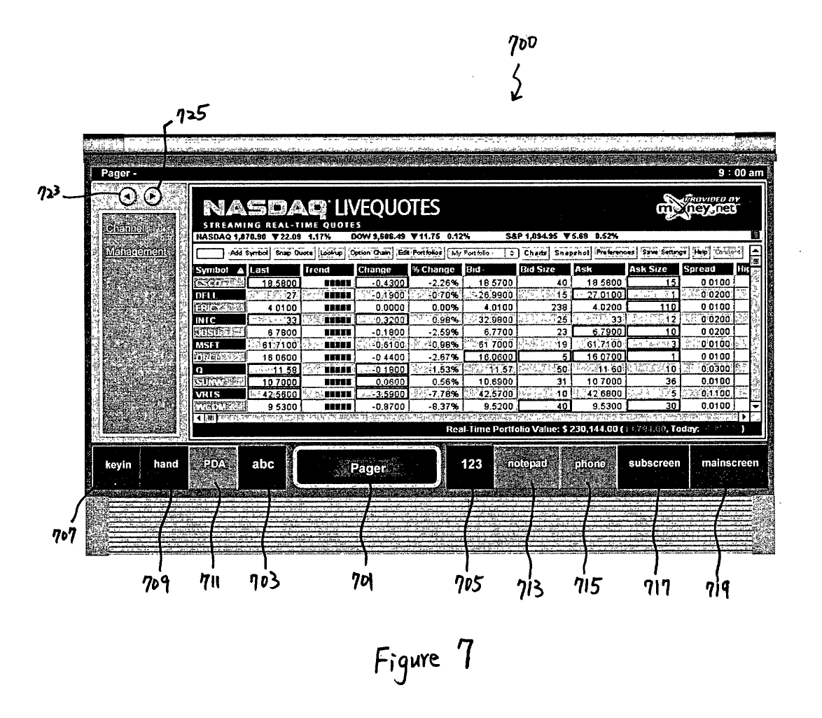

As mentioned, the sub-screen 107 is a touch-screen type LCD, thereby allowing the user to interact with an embedded system operating system (the embedded system OS) or various software and firmware applications of dual-touch-screen mobile computer 100 by physically contacting sub-screen 105. According to the preferred embodiment, the sub-screen 107 can be used for displaying a computer input user interface (the computer input UI) or various embedded system user interfaces (the embedded system UIs) that are supported by the computer OS and/or the embedded system OS. The embedded system OS can be a Microsoft Pocket PC 2002, a Microsoft Window CE NET, an embedded Linux OS, or one of the Palm operating systems, etc. More specifically, the embedded system OS of embedded system module 1003 can cause sub-screen 107 to switch between the computer input UI and the embedded system UIs according to input data or commands received from the user. When the computer input UI is selected, e.g., when computer module 1001 is turned on, the embedded system OS of embedded system module 1003 causes a virtual keyboard 200 or a virtual handwriting board 300 to be displayed on sub-screen 107. The embedded system module 1003 communicates with computer module 1001, thereby allowing the user to input data and commands for computer module 1001 using the virtual keyboard 200 or the virtual handwriting board 300 as illustrated in FIGS. 2 and 3, respectively. Moreover, the embedded system U's of dual-touch-screen mobile computer 100 may include a virtual notepad 400 as illustrated in FIG. 4, a personal digital assistant user interface 500 (the PDA UI illustrated in FIG. 5), a mobile phone user interface 600 (the mobile phone UI illustrated in FIG. 6), a pager user interface 700 (the pager UI illustrated in FIG. 7), or a wireless email and/or Internet service user interfaces, etc. In the preferred embodiment, a displayed screen on sub-screen 107 can be rotated 1800, thereby allowing the user to treat sub-screen 107 as a main screen. For instance, the user may press main-screen button 219 to rotate by 180° the screens displayed on main screen 105 and on sub-screen 107 and may press sub-screen button 217 to come back to a default setting.

As shown in FIG. 2, in addition to all, or almost all, the typical keys of a conventional notebook computer keyboard, the virtual keyboard 200 further includes virtual touch pad 201, virtual left and right mouse emulation keys 203, 205 (M-l and M-r), and other virtual functional keys such as key-in switch key 207, hand switch key 209, PDA switch key 211, notepad switch key 213, phone switch key 215, sub-screen switch key 217, and main-screen switch key 219. Many of the virtual functional keys allow the user to switch between predefined user interfaces that are supported by mobile computer 100, as will be explained in the following paragraphs. Except for some of the above-mentioned functional keys, preferably the layout of virtual keyboard 200 basically mimics the keyboard of the conventional notebook computer to provide the user a familiar input interface. Thus, the user can simply “type” data or commands into mobile computer 100 by touching virtual keys of virtual keyboard 200 using a stylus, a touch pen, or the user's own fingers, etc. The user can define the cursor position using virtual touch pad key 201 to drag a cursor to a desired position. The user can also select an item shown in main screen 105 by double clicking virtual touch pad key 201 or by double clicking virtual left mouse emulation key 203 (M-l) while the cursor is pointing at the item. Moreover, the user can display various pull-down manuals on main screen 105, based on a current position of the cursor on main screen 105, by clicking virtual right mouse emulation key 205 (M-r), and then selecting a desirable option in the pull-down manual by clicking virtual left mouse emulation key 203 (M-l). All of these operations are essentially similar to operating a conventional notebook computer having a physical keyboard therewith or a mouse device connected thereto.

According to the preferred embodiment, the embedded system module 1003 has a handwriting recognition application installed therein and may cause virtual handwriting board 300 to be displayed on sub-screen 107, as shown in FIG. 3 of the application. This virtual handwriting board 300 allows the user to input data or commands by directly writing on sub-screen 107. Referring to FIG. 3, the virtual handwriting board 300 has writing area 323 adapted to receive alphanumeric information written thereon. The writing area 323 may be divided to a text writting area and a numeric writting area, as shown in FIG. 3. Generally, the virtual keyboard 200 is a default setting for the computer input UI of dual-touch-screen mobile computer 100. The user, however, can set virtual handwriting board 300 as a primary input method by designating virtual handwriting board 300 as the default setting of the computer input UI. As shown in FIG. 2, the user can also switch freely between virtual keyboard 200 and virtual handwriting board 300 by pressing hand switch key 209 of virtual keyboard 200. In another preferred embodiment, both the computer OS and the embedded system OS of dual-touch-screen mobile computer 100 support user interfaces that can display and receive input information in multiple languages, such as English, Chinese, French, Japanese, etc. Consequently, the user can switch language environments and input data or commands in one or more languages by “typing” on virtual keyboard 200 or “writing” on virtual handwriting board 300 shown on sub-screen 107.

As shown in FIG. 3, the virtual handwriting board preferably includes language switch key 325 for switching between predetermined input languages (such as English, Chinese, French, and Japanese), clear key 329 for clearing written information currently displayed on writing area 323, key-in switch key 307 for switching to virtual keyboard 200, abc switch key 303 for switching to receive letter input information, and 123 switch key 305 for switching to receive numeric input information. In addition, the handwriting board 300 also includes PDA switch key 311 for switching to the PDA UI 500, notepad switch key 313 for switching to the virtual notepad 400, phone switch key 315 for switching to the mobile phone UI 600, sub-screen switch key 217, and main-screen switch key 219.

Similar to virtual handwriting board 300, the virtual notepad 400 also includes key-in switch key 407, hand switch key 409 for switching to virtual handwriting board 300, PDA switch key 411, phone switch key 415, sub-screen switch key 417, and main-screen switch key 419, as shown in FIG. 4. All of these switching keys of virtual notepad 400 perform similar switching functions as those performed by their counterparts in virtual keyboard 200 or in virtual handwriting board 300. Therefore, there is no need to explain the functions of these switch keys again. In the preferred embodiment, the virtual notepad 400 is performed under the embedded system environment controlled by the embedded system module 1003 and not under the computer module 1001. In another embodiment, the virtual notepad 400 can be implemented within both the embedded system module 1003 and the computer module 1001.

The embedded system module 1003 can be installed with the embedded system OS, such as Microsoft Window CE NET, Microsoft Pocket PC 2002, Linux OS, Palm operating systems, Symbian EPOC, etc. When the computer module 1001 is turned off and the embedded system module 1003 is turned on, the embedded system module 1003 displays one of the embedded system U's on sub-screen 107 for performing various embedded system functions. Alternately, the user may also switch between the computer input UI and the embedded system UIs, such as between virtual keyboard 200 and the PDA UI 500 or the mobile phone UI 600, by touching a corresponding functional key of virtual keyboard 200 or virtual handwriting board 300, such as PDA switch key 211, 311 or phone switch key 215, 315 respectively of virtual keyboard 200 or of virtual handwriting board 300.

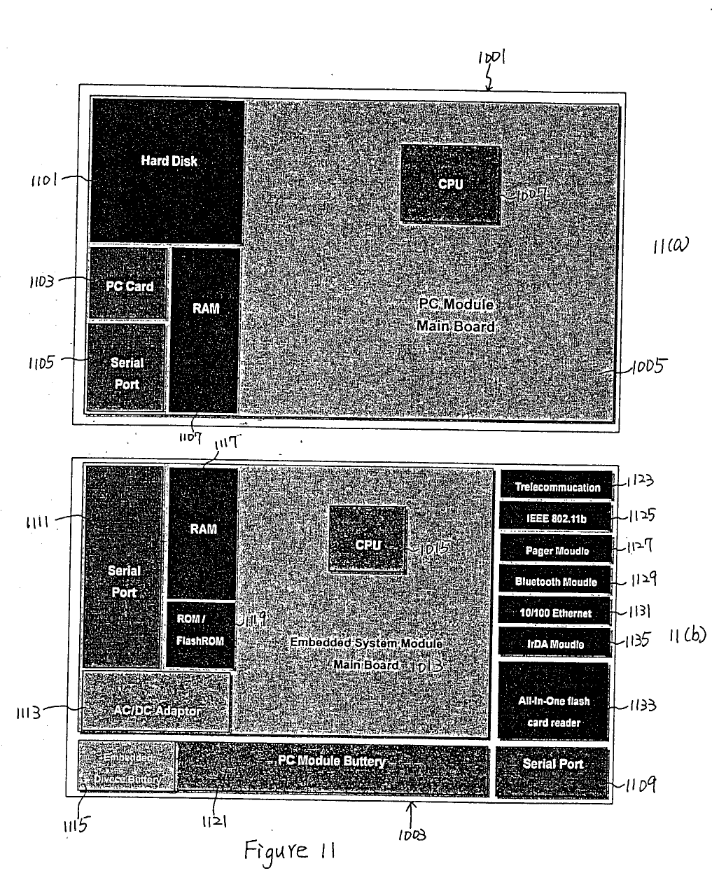

In the preferred embodiment, the provided embedded system functions include practically all or similar software applications that are currently available in a conventional personal digital assistant (PDA), such as Compaq/HP iPAQ, HP Jornada, SONY Clie, Palm PDA, etc. For example, the provided embedded system functions can include a personal calendar, an address/contact book, Microsoft's Pocket Word, Pocket Excel, Pocket Outlook, etc. As a result, the dual-touch-screen mobile computer 100 can work like a conventional PDA. In addition, preferably the embedded system functions also include pager and mobile phone applications as well as applications for other smart handheld devices. For instance, the embedded system module 1003 may include pager module 1127, as shown in FIG. 11, for receiving and sending messages like a conventional pager. The embedded system module 1003 may also include a module for mobile phone communication (i.e., the communication module 1123 shown in FIG. 11). The communication module 1123 may include circuits that support a Smart Phone interface and functions and also circuits that support GSM, GPRS, and/or 3G wireless network communication protocols.

FIG. 5 illustrates the PDA UI 500 according to the preferred embodiment of the present invention. As shown in FIG. 5, a main screen area of the PDA UI 500 is displayed with a number of application icons, such as Address, Calculator, Card Info, etc. To run an application under PDA UI 500, the user simply double clicks the relevant application icon to invoke the application. Similar to virtual handwriting board 300, the PDA UI 500 includes key-in switch key 507, hand switch key 509 for switching to virtual handwriting board 300, abc switch key 503 for switching to receive letter input information, 123 switch key 505 for switching to receive numeric input information, phone switch key 515, sub-screen switch key 517, and main-screen switch key 519. All of these switching keys of PDA UI 500 perform similar switching functions as those performed by their counterparts in virtual keyboard 200 or in virtual handwriting board 300. Therefore, we need not explain the functions of these switch keys again.

Referring to FIG. 6, the mobile phone UI 600 includes numeric keypad 631 for entering phone numbers or inputting numeric data, Phone Number area for displaying the phone number of a present phone call, Pager key 623 for switching to pager UI 700, Hang Up key 625 for disconnecting a call, and Calling key 627 for placing a call. The mobile phone UI also has a hierarchical menu section 629 for displaying mobile phone function menus or personal phone book information. Likewise, the mobile phone UI 600 includes key-in switch key 607, hand switch key 609 for switching to virtual handwriting board 300, PDA switch key 611, abc switch key 603 for switching to receive letter input information, 123 switch key 605 for switching to receive numeric input information, notepad switch key 613, sub-screen switch key 617, and main-screen switch key 619. All of these switching keys of mobile phone UI 600 perform similar switching functions as those performed by their counterparts in virtual keyboard 200 or in virtual handwriting board 300. Therefore, we need not explain the functions of these switch keys again.

FIG. 7 illustrates the pager UI 700 according to the preferred embodiment of the present invention. As shown in FIG. 7, the pager UI 700 includes a display area 721 for displaying received information, such as the NASDAQ quotes of stock prices of various companies. The pager UI 700 also has left and right arrow keys 723, 725 for switching between received data. In addition, the pager UI 700 includes key-in switch key 707, hand switch key 709 for switching to virtual handwriting board 300, PDA switch key 711, abc switch key 703 for switching to receive letter input information, 123 switch key 705 for switching to receive numeric input information, notepad switch key 713, mobile phone switch key 715, sub-screen switch-key 717, and main-screen switch key 719. All of these switching keys of pager UI 700 perform similar switching functions as those performed by their counterparts in virtual keyboard 200 or in virtual handwriting board 300. Therefore, we need not explain the functions of these switch keys again.

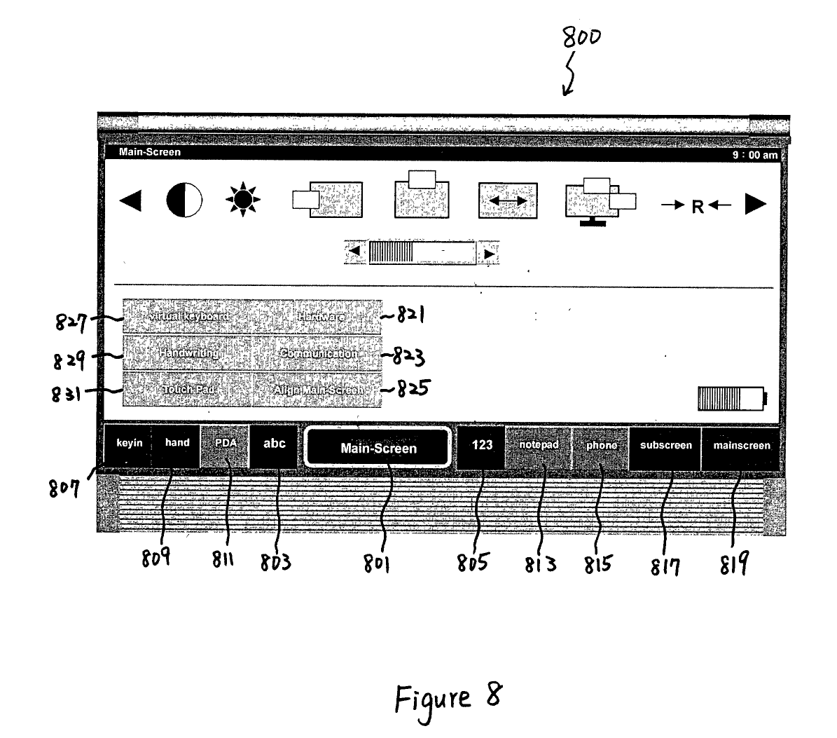

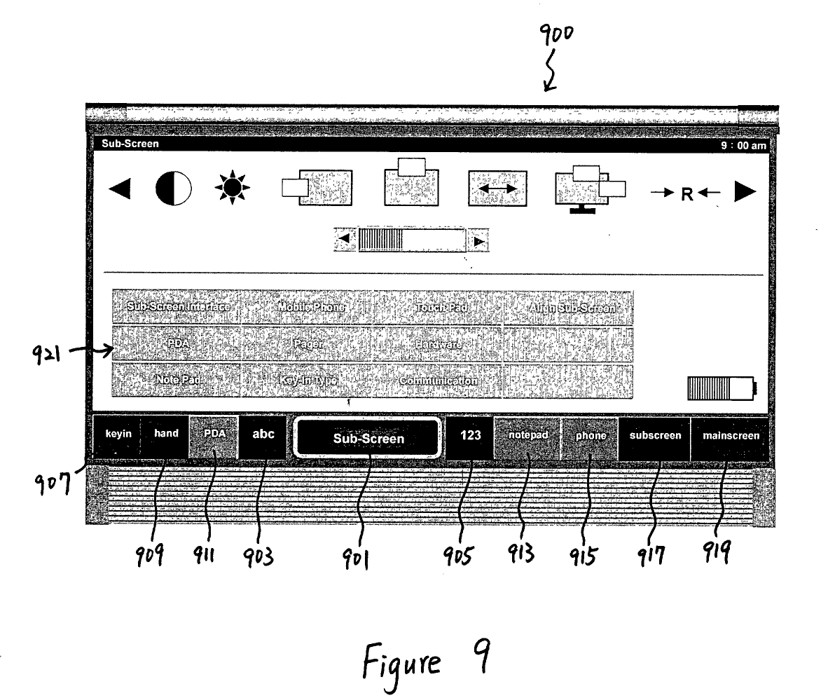

FIG. 8 shows an exemplary screen of the computer user interface 800 displayed on the main screen 105 according to the preferred embodiment. As shown in FIG. 8, the computer user interface 800 can display a status of the virtual keyboard setting on a virtual keyboard indication button 827, a status of the virtual handwriting setting on a virtual handwriting board indication button 829, and a status of the virtual touch pad setting on a touch pad indication button 831. In another embodiment, theses indication buttons can also be used for switching between corresponding settings. For instance, the virtual keyboard indication button 827 can be used for switching to virtual keyboard 200, the virtual handwriting board indication button 829 can be used for switching to virtual handwriting board 300, the touch pad indication button 831 can be used for switching to touch pad 201. In addition, preferably a Hardware key 821 is used for monitoring status of the mobile computer hardware, a communication key 823 is used for performing communication functions, and an Align Main-Screen is used for aligning main screen 105. The computer user interface 800 may also include various functional switch keys, as shown in FIG. 8. These functional switch keys are already well explained above and, thus, will not be explained again. Likewise, FIG. 9 illustrates an exemplary screen displayed on sub-screen 107. The features and icons shown in FIG. 9 are either explained above, are similar thereto, or are quite self-explanatory. For instance, a status displaying area 921 including many indication buttons to show status of the functional settings, such as the PDA, the pager, the mobile phone, etc. In another embodiment, these indication buttons can function as switches for switching between corresponding settings.

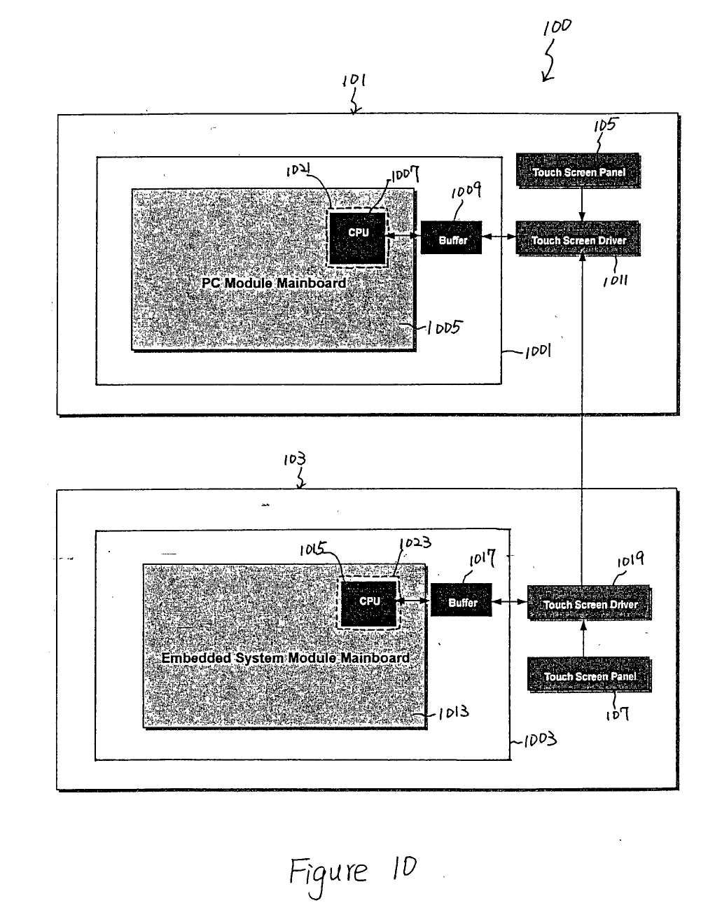

FIG. 10 illustrates a simplified block diagram of the dual-touch-screen mobile computer 100. As shown in FIG. 10, the dual-touch-screen mobile computer 100 includes main screen portion 101 and sub-screen portion 103. The main screen portion 101 includes computer module 1001, main screen 105 (which is a touch screen panel), and touch screen driver 1011. The sub-screen portion 103 includes embedded system module 1003, sub-screen 107 (which is also a touch screen panel), and touch screen driver 1019. The computer module 1001 has PC module mainboard 1005 with a socket 1021 (shown in dash lines) for installing a computer central processor unit 1007 (the computer CPU 1007) therein. In the preferred embodiment, the computer CPU 1007 is an Intel Pentium 4M series CPU with a clock speed of 1.6 GHz. Alternately, computer CPU 1007 can be a Pentium 4M series CPU with other clock speeds, an Intel Pentium 4 series CPU, an Intel Pentium III/III-M series CPU, an Intel Celeron CPU, an AMD Athlon 4 series CPU, a Transmeta Crusoe series CPU, or any other computer CPU that is suitable for dual-touch-screen mobile computer 100.

The computer CPU 1007 is electrically connected to computer buffer 1009 for receiving and sending data from/to touch screen driver 1011. The touch screen driver 1011 is electrically coupled to main screen (touch screen panel) 105, for receiving information from main screen 105. When the user enters data and/or commands by physically touching or writing on main screen 105, the touch screen driver 1011 converts the data/commands from main screen (touch screen panel) 105 into digital data and then sends this digital data to computer CPU 1007 via computer buffer 1009 for processing.

Correspondingly, the embedded system module 1003 has Embedded System module mainboard 1013 with a socket 1023 (shown in dash lines) for installing an embedded system central processor unit 1015 (the embedded system CPU 1015). In the preferred embodiment, the embedded system CPU 1015 is an Intel PXA series 400 MHz CPU. Alternately, the embedded system CPU 1015 can also be an ARM RISC series CPU, an Intel StrongARM series CPU, a Motorola DragonBall CPU, or any other embedded system CPU or digital signal processor (DSP) that is suitable for dual-touch-screen mobile computer 100.

The embedded system CPU 1015 is electrically connected to embedded system buffer 1017 for receiving and sending data from/to embedded system touch screen driver 1019. The embedded system touch screen driver 1019 is electrically coupled to sub-screen (touch screen panel) 107 for receiving information from sub-screen 107. When the user enters data and/or commands by physically touching or writing on sub-screen 107, the touch screen driver 1019 converts the data/commands from sub-screen 107 into digital data and then sends this digital data to embedded system CPU 1015 via embedded system buffer 1017 for processing. Alternately, the touch screen driver 1019 may send converted digital data to touch screen driver 1011 of main screen portion 101 to be processed by computer CPU 1007.

FIG. 11a shows a simplified, yet more detailed, block diagram of computer module 1001 of dual-touch-screen mobile computer 100, according to the preferred embodiment. As shown in FIG. 11a, the computer module 1001 of main screen portion 101 comprises PC module mainboard 1005, hard disk 1101, PC card port 1103, computer serial port 1105, and computer random access memory 1107 (the computer RAM 1107). The PC card port 1103 supports both type I and type II PCMCIA cards, and the computer serial port 1105 includes an USB port supporting USB 1.1 and/or 2.0 connection protocols. Moreover, the PC module mainboard 1005 has, inter alia, the computer CPU 1007 installed thereon.

FIG. 11b shows a simplified, yet more detailed, block diagram of sub-screen portion 103 of dual-touch-screen mobile computer 100, according to the preferred embodiment. The sub-screen portion 103 comprises embedded system module 1003, AC/DC adaptor unit 1113 for receiving AC electrical power from an electrical outlet, and other functional modules, which will be explained in further detail below. The embedded system module 1003 includes embedded system module mainboard 1013, embedded system serial port 1111, embedded system random access memory 1117 (the embedded system RAM 1117), and embedded system read-only-memory 1119 (the embedded system ROM 1119). Similar to the PC module mainboard 1005, the embedded system module mainboard 1013 has, inter alia, the embedded system CPU 1015 installed thereon. In addition to the embedded system module 1003, the sub-screen portion 103 has embedded system battery set 1115 for providing electrical power to components of embedded system module 1003 and to some functional modules of sub-screen portion 103. In the preferred embodiment, the embedded system battery set 1115 is separated from computer battery set 1121 that provides electricity to main screen portion 101. Separating embedded system battery set 1115 from computer battery set 1121 allows sub-screen portion 103 to be turned on without simultaneously turning on main screen portion 101. Furthermore, components of sub-screen portion 103, e.g., the embedded system module 1003, generally consume much less electrical power per time unit than components of main-screen portion 101, e.g., the computer module 1001. For instance, both the main screen 105 and computer CPU 1007 of computer module 1001 consume much more electricity than their counterparts, i.e., the sub-screen 107 and the embedded system CPU 1015 of embedded system module 1003. Therefore, with the separated embedded system battery set 1115 and the computer battery set 1121, the user can operate embedded systems of sub-screen portion 103, such as performing various PDA tasks, reading an e-book, or receiving and/or editing emails and pager messages, etc., while turning off computer module 1001 to save electricity. In the preferred embodiment, both computer battery set 1121 and embedded system battery set 1115 are made of lithium-ion battery cells.

In addition to the above-mentioned components, the sub-screen portion 103 further includes communication module 1123, wireless network module 1125, pager module 1127, Bluetooth module 1129, network card port 1131, memory card reader 1133, and serial port 1109. The communication module 1123 supports one or more wireless phone communication protocols such as GSM (Global System for Mobile Communication), GPRS (General Packet Radio Service), CDMA (Code Division Multiple Access), 3G (Third Generation), etc. The embedded system OS supports a smart-phone interface that combines functions of a PDA and a cellular phone. Accordingly, the dual-touch-screen mobile computer 100 can function like a mobile phone and the user may also surf on the Internet wirelessly. Moreover, the communication module 1123 may also include an internal modem with one RJ-11 phone jack for connecting to a home/office/wall phone jack via a phone cord.

The wireless network module 1125 supports wireless local area network (LAN) protocols such as IEEE 802.11a, b, or g. With the built-in wireless network module 1125, the user can connect the dual-touch-screen mobile computer 100 wirelessly to various external devices, such as a keyboard, a mouse, or a printer that support the wireless network protocols. The sub-screen portion 103 may also include a Bluetooth module 1129 for connecting wireless devices that support the Bluetooth protocol. As compared to devices supporting IEEE 802.11 a/b/g protocols, Bluetooth wireless devices operate within a shorter distance (e.g., within 10 meters from the mobile computer 100) and at a slower speed such as one mbps (mega bytes per second). The Bluetooth technology, however, costs less to be implemented in the mobile computer 100 and the Bluetooth devices are generally less expensive. In the preferred embodiment, the dual-touch-screen mobile computer 100 includes infrared module 1035 for wireless connection with external devices that support an infrared link protocol (IrDA) as well. Furthermore, preferably the network card port 1131 supports wired network protocols such as a 10/100 Ethernet local area network protocol. All of the communication, wired and wireless network modules/ports are electrically coupled to both computer module 1001 and embedded system module 1003, thus allowing them to be operated under either the computer OS environment or the embedded system OS environment.

The sub-screen portion 103 preferably includes pager module 1127, thus allowing the user to subscribe to pager services from a provider and to use the mobile computer 100 as a pager. To save electricity, preferably pager module 1127 is coupled to embedded system module 1003 and embedded system battery set 1115 only, and it may remain on while computer module 1001 and main screen 105 are turned off.

The memory card reader 1133 can read and/or write data from and/or upon a memory medium such as a compact flash memory card (CF I/II), an IBM Microdrive memory card, a SmartMedia memory card, a Memory Stick memory card, a MultiMedia memory card, or a Secure Digital memory card. In the preferred embodiment, the memory card reader 1133 is a 6-in-1 card reader that can read/write data from/to all six types of memory medium formats mentioned above. In other embodiments, the memory card reader 1133 may be adapted to read/write from/to only one or more types of the memory media. The memory card reader 1133 is electrically connected to both computer module 1001 and embedded system module 1003. Therefore, both computer module 1001 and embedded system module 1003 can communicate with memory card reader 1133 for inputting and/or outputting data from/to a memory medium inserted in memory card reader 1133.

In the preferred embodiment, no media drive, such as a floppy disk drive, a CDROM drive, a CD-ROM/RW drive, a DVD-ROM drive, or a DVD-ROM/RW drive, is provided within the system to save space and weight for dual-touch-screen mobile computer 100. Nevertheless, the computer OS or the embedded system OS of mobile computer 100 preferably supports all of these media drives, thus allowing any of these media drives to be easily connected to the dual-touch-screen mobile computer 100 via a serial port or a USB port of the mobile computer 100 or via a docking station connected to the mobile computer 100. In another preferred embodiment, one or more of these media drives can be integrated within the dual-touch-screen mobile computer 100.

According to the preferred embodiment, the hard disk 1101 has a capacity of 20 gigabytes (GB). One or more of the serial ports 1105, 1109, and 1111 includes an IEEE 1394 high-speed serial port and at least 2 USB ports that support USB 1.1 and/or 2.0 connection protocols. Moreover, the dual-touch-screen mobile computer 100 has a parallel port (not shown) and a video output port (e.g., a VGA output) (not shown). The computer RAM 1107 has a capacity of 256 megabytes (MB) DDR SDRAM, the embedded system RAM 1117 has a capacity of 64 MB SDRAM, and the embedded system ROM 1119 has a capacity of 64 MB SDRAM. In other embodiments, the hard disk 1101 can have a capacity other than 20 GB (e.g., 40 GB). Likewise, the computer RAM 1107, the embedded system RAM 1117, and the embedded system ROM 1119 can have capacities higher than 256 MB, 64 MB, and 64 MB, respectively, and they can be made of other types of memory circuits, such as DRAM, RDRAM, etc.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A portable electronic device, comprising:
a main screen portion, said main screen portion comprising a computer module and a main screen capable of displaying a computer user interface thereon; and
a sub-screen portion pivotally coupled to said main screen portion, said sub-screen portion comprising an embedded system module and a sub-screen capable of displaying an embedded system user interface or a computer input user interface thereon,
wherein both the main screen and the sub-screen are touch-screen type flat panel display screens capable of receiving input information by physically touching a surface of the main screen or a surface of the sub-screen.

2. The portable electronic device of claim 1, wherein the computer module has a computer operating system installed therein and the embedded system module has an embedded system operating system installed therein.

3. The portable electronic device of claim 2, wherein the computer operating system is a Microsoft Window operating system and the embedded system operating system is a Microsoft Window CE NET operating system.

4. The portable electronic device of claim 2, wherein the computer operating system is a Linux operating system and the embedded system operating system is an embedded Linux operating system.

5. The portable electronic device of claim 1, wherein the computer input user interface is user determinably selected from a plurality of input methods including a virtual keyboard and a virtual handwriting board, and the embedded system user interface is user determinably selected from a plurality of embedded system selections including a PDA user interface, a virtual notepad, a mobile phone user interface, and a pager user interface.

6. The portable electronic device of claim 5, wherein
each of the plurality of input methods includes at least one switch key for switching from an input method displayed on the sub-screen to another input method by clicking a corresponding switch key of the displayed input method, and
each of the plurality of embedded system selections includes at least one switch key for switching from an embedded system selection displayed on the sub-screen to another embedded system selection by clicking a corresponding switch key of the displayed embedded system selection.

7. The portable electronic device of claim 5, wherein
the virtual keyboard of the computer input user interface further includes a plurality of embedded system switch keys for switching to an embedded system selection by clicking a corresponding embedded system switch key, and
each of the embedded system selections respectively further includes a keyboard switch key for switching to the virtual keyboard by clicking the keyboard switch key.

8. The portable electronic device of claim 1, wherein said computer module further comprises a computer main-board having a socket for mounting a computer central processor unit thereon and said embedded system module comprises an embedded system main-board having a socket for mounting an embedded system central processor unit thereon.

9. The portable electronic device of claim 8, wherein said computer central processor unit is an Intel Pentium series microprocessor.

10. The portable electronic device of claim 8, wherein said embedded system central processor unit is an Intel PXA series microprocessor.

11. The portable electronic device of claim 8, wherein said computer central processor unit is an AMD Athlon series microprocessor.

12. The portable electronic device of claim 8, wherein said embedded system central processor unit is an ARM RISC series microprocessor.

13. The portable electronic device of claim 8, wherein said computer central processor unit is a Transmeta Crusoe series microprocessor.

14. The portable electronic device of claim 1, wherein said sub-screen portion further comprises:
a mobile phone communication module, said mobile phone communication module supporting at least one of GSM, GPRS, CDMA, or 3G wireless phone communication protocols;
a pager module, said pager module being capable of receiving and sending pager messages;
a wireless local area network portion, said wireless local area network portion being capable of providing a wireless local area network connection for the portable electronic device; and
a wired network module, said wired network module being capable of providing a wired local area network connection for the portable electronic device.

15. The portable electronic device of claim 14, wherein said wireless local area network portion comprises at least one of:
an IEEE 802.11 communication module, said IEEE 802.11 communication module supporting at least one of IEEE 802.11a, IEEE 802.11b, and IEEE 802.11g wireless local area network protocols; and
a Bluetooth module, said Bluetooth module supporting a Bluetooth wireless local area protocol.

16. The portable electronic device of claim 14, wherein said wired network module supports a 10/100 Ethernet local area network protocol.

17. The portable electronic device of claim 1, wherein said sub-screen portion further comprises:
a computer battery set for providing electricity to said main screen portion;
an embedded system battery set for providing electricity to said sub-screen portion; and
a memory card reader, said memory card reader being capable of reading data from and writing data to a memory medium.

18. The portable electronic device of claim 17, wherein said memory card reader is a multi-card reader adapted to read data from and write data to at least one of a plurality of memory medium formats including a compact flash memory card, an IBM Microdrive memory card, a SmartMedia memory card, a Memory Stick memory card, a MultiMedia memory card, and a Secure Digital memory card.

19. The portable electronic device of claim 1, wherein
the computer module further comprises:
a hard disk for storing data;
a computer serial port;
a computer card port, said computer card port being adapted to support both types I and II PCMCIA cards; and
a computer RAM memory bank, and
the embedded system module further comprises:
an embedded system RAM memory bank;
an embedded system ROM memory bank; and
an embedded system serial port.

20. A portable computer, comprising:
a main screen portion, said main screen portion comprising a computer module and a main screen capable of displaying a computer user interface thereon; and
a sub-screen portion pivotally coupled to said main screen portion, said sub-screen portion comprising an embedded system module and a sub-screen capable of displaying an embedded system user interface or a computer input user interface thereon,
wherein said computer module includes
a computer main-board with a socket for mounting a computer central processor unit thereon,
a hard disk for storing data,
a computer card port supporting both types I and II PCMCIA cards,
a computer RAM memory bank, and
a computer serial port, and
said embedded system module includes
an embedded system main-board with a socket for mounting an embedded system central processor unit thereon,
an embedded system RAM memory bank,
an embedded system ROM memory bank, and
an embedded system serial port,
both the main screen and the sub-screen being touch-screen type flat panel display screens capable of receiving input information by physically touching a surface of the main screen or a surface of the sub-screen.

21. The portable computer of claim 20, wherein said sub-screen portion further comprises:
a mobile phone communication module, said mobile phone communication module supporting at least one of GSM, GPRS, CDMA, or 3G wireless communication protocols;
a pager module, said pager module being capable of receiving and sending pager messages;
a wireless local area network portion, said wireless local area network portion being capable of providing a wireless local area network connection for the portable computer;
a wired network module, said wired network module being capable of providing a wired local area network connection for the portable computer;
a computer battery set for providing electricity to said main screen portion;
an embedded system battery set for providing electricity to said sub-screen portion; and
a memory card reader, said memory card reader being capable of reading data from and writing data to a memory medium.

22. The portable computer of claim 21, wherein said memory card reader is a multi-card reader adapted to read data from and write data to at least one of a plurality of memory medium formats including a compact flash memory card, an IBM Microdrive memory card, a SmartMedia memory card, a Memory Stick memory card, a MultiMedia memory card, and a Secure Digital memory card.

23. The portable computer of claim 21, wherein said wireless local area network portion comprises at least one of:
an IEEE 802.11 communication module, said IEEE 802.11 communication module supporting at least one of IEEE 802.11a, IEEE 802.11b, and IEEE 802.11g wireless local area network protocols; and
a Bluetooth module, said Bluetooth module supporting a Bluetooth wireless local area protocol.

24. An electronic device, comprising:
main screen means for displaying a computer main user interface;
sub-screen means for displaying an embedded system user interface or a computer input user interface;
computer means for performing essential computer data processing tasks, said computer means being coupled to said main screen means to cause said main screen means to display the computer main user interface;
embedded system means for performing a plurality of embedded system tasks, said embedded system means being coupled to said sub-screen means to cause said sub-screen means to display a selected embedded system user interface or a selected computer input user interface in response to an embedded system task performed.

25. The electronic device of claim 24, wherein the computer input user interface is user determinably selected from a plurality of input methods including a virtual keyboard, a virtual handwriting board, and a virtual notepad, and the embedded system user interface is user determinably selected from a plurality of embedded system selections including a PDA user interface, a mobile phone user interface, and a pager user interface.

26. The electronic device of claim 24, further comprising:
means for providing telecommunication and wired and wireless local area network communication;
means for providing a serial port connection;
means for providing electricity to said main screen means and said computer means; and
means for providing electricity to said sub-screen means and said embedded system means.

27. The electronic device of claim 26, wherein said means for providing telecommunication and wired and wireless local area network communication comprises:
a mobile phone communication module, said mobile phone communication module supporting at least one of GSM, GPRS, CDMA, or 3G wireless communication protocols;
a pager module, said pager module being capable of receiving and sending pager messages;
a wireless local area network portion, said wireless local area network portion being capable of providing a wireless local area network connection for the electronic device; and
a wired network module, said wired network module being capable of providing a wired local area network connection for the electronic device.

28. The electronic device of claim 27, wherein said wireless local area network portion comprises at least one of:
an IEEE 802.11 communication module, said IEEE 802.11 communication module supporting at least one of IEEE 802.11a, IEEE 802.11b, and IEEE 802.11g wireless local area network protocols; and
a Bluetooth module, said Bluetooth module supporting a Bluetooth wireless local area protocol.

29. The electronic device of claim 24, further comprising means for reading data from and writing data to a memory medium.

30. The electronic device of claim 29, wherein said memory reading/writing means is adapted to read data from and write data to at least one of a plurality of memory medium formats including a compact flash memory card, an IBM Microdrive memory card, a SmartMedia memory card, a Memory Stick memory card, a MultiMedia memory card, and a Secure Digital memory card.

31. The electronic device of claim 24, wherein both said main screen means and said sub-screen means are touch-screen type flat panel display screens capable of receiving input information by physically touching a surface of said main screen means or a surface of said sub-screen means.

32. A portable electronic device, comprising:
a computer module adapted to perform computer data processing tasks, said computer module having a main screen for displaying a computer main user interface; and
an embedded system module coupled to said computer module, said embedded system module being adapted to perform embedded system tasks and to cause to display an embedded system user interface or a computer input user interface in the portable electronic device, wherein
the computer main user interface is supported by a computer operating system and the embedded system user interface and the computer input user interface are supported by an embedded system operating system, and
the main screen is a touch-screen type flat panel display screen.

33. The portable electronic device of claim 32, wherein the embedded system user interface and the computer input user interface are displayed on the main screen.

34. The portable electronic device of claim 32, wherein said embedded system module further comprises a sub-screen adapted to display the embedded system user interface and the computer input user interface, said sub-screen being a touch-screen type flat panel display screen.

35. The portable electronic device of claim 32, wherein the computer input user interface is user determinably selected from a plurality of input methods including a virtual keyboard and a virtual handwriting board, and the embedded system user interface is user determinably selected from a plurality of embedded system selections including a PDA user interface, a virtual notepad, a mobile phone user interface, and a pager user interface.

36. The portable electronic device of claim 32, wherein said embedded system module further comprises:
a mobile phone communication module, said mobile phone communication module supporting at least one of GSM, GPRS, CDMA, or 3G wireless phone communication protocols;
a pager module, said pager module being capable of receiving and sending pager messages;
a wireless local area network portion, said wireless local area network portion being capable of providing a wireless local area network connection for the portable electronic device; and
a wired network module, said wired network module being capable of providing a wired local area network connection for the portable electronic device.

37. The portable electronic device of claim 36, wherein
said wireless local area network portion comprises at least one of:
an IEEE 802.11 communication module, said IEEE 802.11 communication module supporting at least one of IEEE 802.11a, IEEE 802.11b, and IEEE 802.11g wireless local area network protocols; and
a Bluetooth module, said Bluetooth module supporting a Bluetooth wireless local area protocol, and
said wired network module supports a 10/100 Ethernet local area network protocol.

38. The portable electronic device of claim 32, wherein
said computer module further comprises a computer battery set for providing electricity to said computer module, and
said embedded system module further comprises:
an embedded system battery set for providing electricity to said embedded system module; and
a memory card reader, said memory card reader being capable of reading data from and writing data to a memory medium.
